(19) United States
(12) Patent Application Publication
(10) Pub. No.: US 2020/0053952 A1
(43) Pub. Date: Feb. 20, 2020

(54) SYSTEMS AND METHODS FOR TRACKING AND TRACING PERFORMANCE OF AGRICULTURAL TASKS

(71) Applicant: AgBiome, Inc., Durham, NC (US)

(72) Inventors: John C. Rabby, Wake Forest, NC (US); David L. Gerrard, Charlotte, NC (US)

(73) Assignee: AgBiome, Inc., Durham, NC (US)

(21) Appl. No.: 16/540,407

(22) Filed: Aug. 14, 2019

Related U.S. Application Data
(60) Provisional application No. 62/718,629, filed on Aug. 14, 2018.
(60) Provisional application No. 62/832,458, filed on Apr. 11, 2019.

(51) Int. Cl. A01B 79/00; A01C 21/00; H04L 9/06; G06F 16/29; H04W 4/029

(52) U.S. Cl. CPC A01B 79/005; A01C 21/007; H04L 9/0643; G06Q 50/02; H04W 4/029; H04L 2209/38; G06F 16/29

(57) ABSTRACT

A data registry can be maintained that stores parameters associated with one or more agricultural fields. For each of the one or more agricultural fields, the parameters include a) one or more geolocation parameters defining a location of the agricultural field, b) one or more completed agricultural tasks performed upon the agricultural field, c) if a compliance requirement is associated with the agricultural field, a compliance status that indicates whether or not the compliance requirement is satisfied; and d) if an agricultural commodity was harvested at the agricultural field, one or more unique identifiers that is associated with the harvested agricultural commodity. When an agricultural task is completed, the parameters and compliance requirement are updated.

### CROSS-REFERENCE TO RELATED APPLICATIONS

This application claims priority from U.S. Provisional Patent Application No. 62/718,629, filed Aug. 14, 2018, and U.S. Provisional Patent Application No. 62/832,458, filed Apr. 11, 2019, which applications are hereby incorporated in their entirety by reference in this application.

### FIELD OF THE INVENTION

The invention is drawn to methods and systems for tracking and tracing agricultural tasks and requirements relating to agricultural fields or products.

### BACKGROUND

Agricultural producers use a variety of practices such as watering, application of pesticides and fertilizers. Producers may choose crops, adjust plant and harvest dates, and plan for crop rotations to limit the effect of pests such as weeds, insects, and fungi. Weed control can include tilling and hoeing by hand. Treatments for managing insects and other pests can include spraying or chemigation. Seeds for some crops can also be genetically engineered to be insect-resistant and herbicide-tolerant.

Agricultural products can include commodities such as fruits and vegetables. Commodities can be harvested and then placed in transport to a storage facility where they can be distributed through different distribution channels and networks to other storage facilities until they eventually reach a retail facility where they are to be sold. In some cases, commodities, for example, corn, can be shipped to a facility where it will be processed to produce a downstream product, for example, animal feed, corn sugar-derived sweeteners, corn flour, or oil.

Agricultural products can also include agricultural treatment products such as herbicides, pesticides, fertilizers, or chemical ingredients of such, can be produced in a plant and placed in transport to different storage facilities. In some cases, the end use of the product is an application to a crop or soil. In other cases, the product can be mixed or combined with a different product to generate an application form of the product. In other cases, the product can undergo a process to alter the product into an application form. The product can be stored in different containers and mixtures prior to being sold and/or applied.

Health and safety relating to the use and consumption of crop/commodities can therefore be an issue, because it may be unknown how a harvested commodity was treated (for example, watering, pesticide, fertilizer) prior to harvesting. Although a product might be labeled as ‘organic’, records to certify compliance with ‘organic’ requirements may be compromised due to lack of verified data. The same goes for other compliance requirements.

An improved and centralized method and system for verifying proper performance of tasks on crops, and tracking and tracing such performance to harvested crops is desirable.

### SUMMARY

Supply chains, especially those for agricultural products such as fresh fruits and vegetables, lack full traceability back to the field and/or block of origin for certification of compliance. Further, mechanisms are lacking for electronic record keeping of verified performed agricultural tasks that can be traced to agricultural products after harvesting. While processes might be in place to capture this data at the farm and either report it to the appropriate federal agency or have it available for periodic audit by government agencies and buyers, efficient platforms to certify these activities in real time and/or tag farm activities to specific farm fields are lacking. For example, existing systems may not have the ability to cross-reference tasks, agricultural products, and/or fields against different requirements (e.g., health and safety, certified organic, etc.) before and directly after they are performed.

Furthermore, where records do exist, they are generated and passed through the production system in paper form, often resulting in errors in time and place of application, delays in recording and certifying practice, and unacceptably high administrative burdens on the farm enterprise. Most compliance is done on a post hoc audit basis from retained paper records, or by signing general compliance statements with the right to audit embedded. These approaches do not prevent potentially harmful or non-compliant product from entering distribution channels nor do they flag or identify out of specification treatment applications on fields and crops before they occur.

An improved and centralized method and system for managing the health, safety, and regulatory compliance of treatments of agricultural products in a farm field is desirable. Tracking information can include timestamped information relating ticket generation, preparation of treatment products to a farm field, application of the treatment products to a farm field, and real-time digital confirmations and acknowledgements by administrators, field supervisors, and farm employees. Processes and tracking described herein can improve the overall reliability of the treatment process by providing verification points along the treatment process, and provide more accurate and reliable records with regard to the treatment of a field or of a crop.

In one embodiment of the present disclosure, a process for tracking and tracing performance of verified agricultural tasks includes: maintaining a data registry having parameters associated with one or more agricultural fields, wherein for each of the one or more agricultural fields, the parameters include a) one or more geolocation parameters defining a location of the agricultural field, b) one or more completed agricultural tasks performed upon the agricultural field, c) if a compliance requirement is associated with the agricultural field, a compliance status that indicates whether or not the compliance requirement is satisfied; and d) if an agricultural commodity was harvested at the agricultural field, one or more unique identifiers that is associated with the harvested agricultural commodity. In response to a verified completion of an agricultural task performed on one of the one or more agricultural fields, the parameters associated with the agricultural field where the verified completed agricultural task was performed are updated. The updated parameters are referenced against the compliance requirement of the agricultural field to determine if the updated parameters violate the compliance requirement. The compliance status is updated, automatically by the data manager, to indicate whether or not the compliance requirement is satisfied.

The above summary does not include an exhaustive list of all embodiments of the present disclosure. It is contemplated that the disclosure includes all systems and methods that can be practiced from all suitable combinations of the various embodiments summarized above, as well as those disclosed in the Detailed Description below and particularly pointed out in the Claims section. Such combinations may have particular advantages not specifically recited in the above summary.

### BRIEF DESCRIPTION OF THE DRAWINGS

Embodiments of the disclosure are illustrated by way of example and not limitation in the figures of the accompanying drawings in which like references indicate similar elements.

FIG. 1 shows a system of managing records of an agricultural field, according to one embodiment.

FIG. 2 illustrates an example of agricultural fields, according to one embodiment.

FIG. 3 shows a process, according to one embodiment.

FIG. 4 shows an example data record of an agricultural field.

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. Modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Agricultural products can include commodities such as fruits and vegetables. These products, prior to harvesting, can be treated by applying agricultural treatment products such as herbicides, fungicides, insecticides, nematicides, fumigants, growth regulators, water, and fertilizers either alone or in combination with each other. The various agricultural treatment products can include either a synthetic chemistry or a biological or a combination thereof. Health and safety relating to the use of these agricultural treatment products and consumption of resulting crop/commodities can be an issue because it may be unknown how the crop was treated prior to harvesting. The treatment products can be applied to crop and/or soil in a field. Treatments with agricultural products can increase production efficiency and prevent damage to crops when performed properly and within guidelines and good practice. As discussed, it can be difficult, however, to determine the treatment history of a field or crop. The treatment history can be used to determine overall compliance with usage standards and reporting of practice to stakeholders such as government agencies, buyers, and others

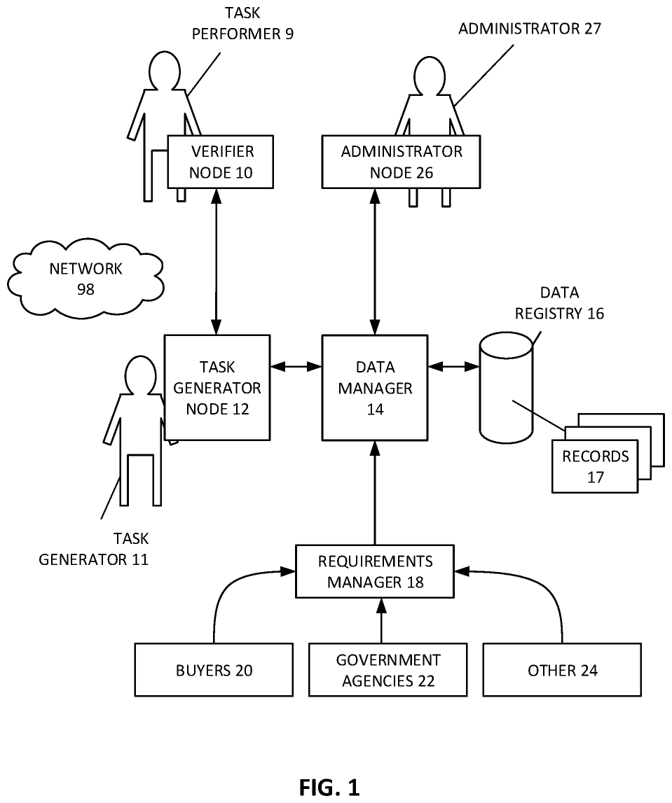

In one embodiment, a system is shown in FIG. 1 for tracking and tracing tasks performed on an agricultural field. Products harvested from the agricultural fields can also be tracked, this maintaining a chain of provenance from production to post-harvest.

A data manager 14 can maintain a data registry having records 17 of agricultural tasks performed on agricultural fields. A data registry can be a database hosted on a networked computer, a combination of multiple databases hosted on a networked computer or over a plurality of networked computers, or a distributed database such as a block chain. The data manager can manage the interface with the data registry, including adding new parameters to the data registry, and performing logic and algorithms to determine when new parameters violate compliance requirements.

In the data registry records, each agricultural field (which can be represented as a unique field identifier) can have parameters associated to it, such as but not limited to, a) one or more geolocation parameters defining a location of the agricultural field, b) one or more completed agricultural tasks performed upon the agricultural field, c) if a compliance requirement is associated with the agricultural field, a compliance status that indicates whether or not the compliance requirement is satisfied; and d) if an agricultural commodity was harvested at the agricultural field, one or more unique identifiers that is associated with the harvested agricultural commodity.

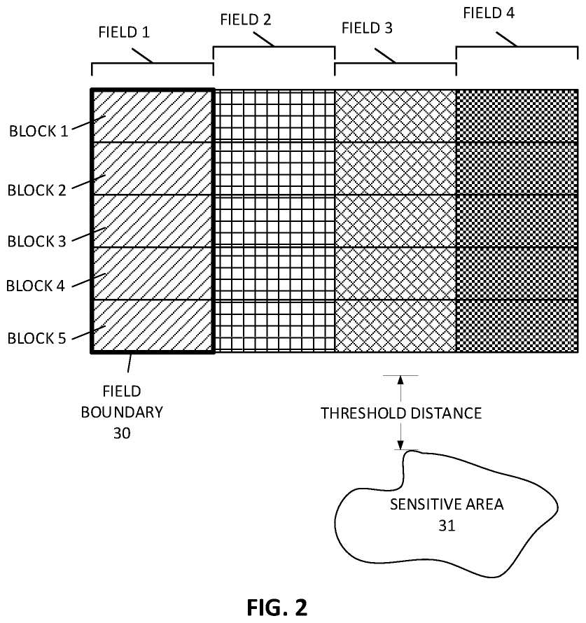

The geolocation parameters of each agricultural field can include latitude and longitude coordinates, or a range thereof. The parameters can define a boundary of the agricultural field (e.g., where crops are grown). For example, boundary 30 of field 1 is shown in FIG. 2. The boundary can be represented as a range of latitude coordinates (e.g., a max and min) and a range of longitude coordinates that define the perimeter of the field. It is contemplated that not all fields are perfect rectangles that align with longitude and latitude lines. Geometrical boundaries can be defined and represented in various ways. For example, a series of latitude and longitude coordinates can represent dots that, when connected, form an outline around the agricultural field. Other representations are known and can be implemented.

In one embodiment, the parameters stored in the data registry further include one or more block identifiers. As shown in FIG. 2, each block identifier can indicate a partitioned area, such as blocks 1-5 of a corresponding agricultural field (e.g., fields 1-4). Accordingly, each agricultural field can have multiple block identifiers. Thus, the data registry can be organized by agricultural field identifier, or by a combination of an agricultural field identifier and a block identifier. Embodiments of the present disclosure discussed in terms of agricultural field can also be applied to a combination of agricultural field and block identifier. In other words, each agricultural field and block identifier can also have associated with it, completed tasks and information thereof.

In one embodiment, a compliance requirement is violated when the agricultural field is determined, based on the geolocation parameters, to be within a distance of a sensitive area 31. Sensitive areas can include, for example, healthcare facilities such as hospitals or nursing homes, schools, open water, and wildlife habitats. An algorithm can cross reference each of the geolocation parameters of each field (and/or block) against known geolocations of sensitive areas to determine whether a threshold distance (as determined by one or more of the compliance requirements) is satisfied. The distances and types of sensitive areas can be defined by specific compliance requirements. If not satisfied (e.g., the field is too close), then the corresponding compliance status indicator of the agricultural field can be set to indicate a non-compliance.

Referring back to FIG. 1, the data manager 14 can maintain the data registry 16 and store and update completed agricultural tasks that have been performed on each agricultural field. The parameters can include the type of task performed—e.g. watering, applying pesticide and/or fertilization, and harvesting. Each agricultural task performed on a field is thereby stored in the data registry records and associated with the field that the task was performed upon, so that provenance of a field is maintained.

If a compliance requirement is associated with the agricultural field (e.g., certified organic, Federal Insecticide, Fungicide, and Rodenticide Act (FIFRA), Worker Protection Standard, and others), then a compliance status indicator can indicate whether or not the compliance requirement is satisfied. This status can reflect a current status based on whether or not the compliance requirement is currently satisfied. In one embodiment, a compliance status indicator can indicate the source of the compliance requirement (e.g., via name or url) and whether or the agricultural field is compliant with the requirement. One field can have one or more requirements. In some cases, not all blocks or fields have requirements.

In one embodiment, an administrator 27 can use an administrator node 26 to associate various requirements with each field. In other words, the administrator can have privileges to define which requirements are relevant to which agricultural fields by associating a compliance status indicator to the agricultural field in the data registry. The data manager can interface with a requirements manager 18 which in turn can interface with various different sources of requirements (e.g., buyers 20, government agencies 22, and others 24) to refer to rules of a particular requirement when determining whether a field is in compliance or not.

The data registry is updated to include the latest tasks performed on the agricultural fields. For example, if a spray treatment for a pesticide is applied to a field, then this task is added to the registry once it is verified (as described further below). An algorithm can check whether the one or more compliance requirements are associated with the agricultural field. If yes, then the task (in this case, a product that is used in the spray treatment) can be referenced against rules that belong to the compliance requirement. If the task violates the requirement, then the status is updated to indicate that the requirement is not satisfied. If the task does not violate the requirement, and all other tasks performed upon the agricultural field do not violate the requirement, then the status can indicate that that the requirement is satisfied.

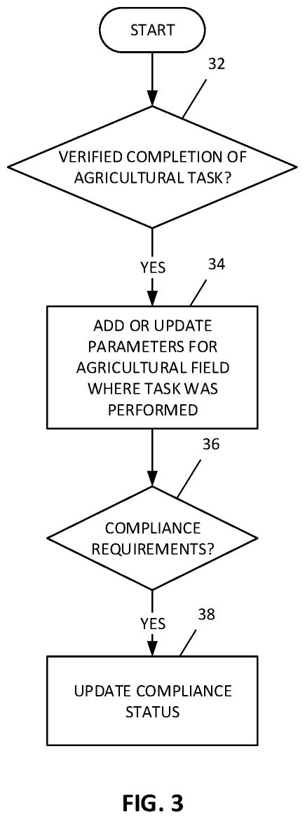

For example, FIG. 3 shows a process or algorithm that can be performed by the system. When a task performer enters a completed task, the system (e.g., the verifier node and/or the ticket generator node) can determine, at block 32, whether the task was performed properly, for example, based on whether the location of the performer is within proximity of the agricultural field, and/or other verification means discussed in other sections of the present disclosure. If the task completion is considered to be ‘verified’, then the system (e.g., the data manager) can, at block 34, add or update parameters for the agricultural field where the task was performed. At block 36, the system can check the data registry to see if any compliance requirements are associated with the agricultural field. If so, then the compliance status in the data registry is updated at block 38. This process forms a data registry that is built upon ‘verified’ tasks, and compliance statuses that reflect the real-time (current) status of an agricultural field.

When a task performer 9 performs an agricultural task, node 10 can generate parameters (e.g., time, location, scanned labels, images, user inputs) to verify completion of the agricultural task. Performing node 10 can have a GPS unit or other sensor system that locates the position of the performer at different times. These parameters can be communicated from the verifier node directly to data manager 14, and/or through the task generator node 12, and/or through other network components using known communication protocols (such as but not limited to 3G, 4G, GSM, Wi-Fi, TCP/IP, Ethernet, Bluetooth, etc.). In response to a verified completion of an agricultural task performed on one of the one or more agricultural fields, data manager can update the parameters associated with the agricultural field where the verified completed agricultural task was performed.

As mentioned, the data manager can reference the updated parameters against the compliance requirement of the agricultural field (or multiple requirements, if the agricultural field has more than one compliance requirement) to determine if the updated parameters violate the compliance requirement. The compliance status can be updated accordingly, to indicate whether or not the compliance requirement is satisfied.

The parameters are compared against one or more buyer provided requirements to determine whether the one or more agricultural fields satisfy the one or more buyer provided requirements. Requirements can have different sources. These requirements can be determined by buyers 20 that generate such requirements (and rules), which can be stored in a database or any data structure. In one embodiment, government agencies 22 can be the source of the requirements. Government agencies can manage their own requirements databases which can be accessed, for example, through an API. A requirements manager 18 can access different requirements and interface with the data manager 14 to determine which requirements (and rules thereof) are to be associated with which agricultural fields. These are just examples of sources, it should be understood that other sources 24 can also provide requirements, for example, a farm administrator 27, a third party accreditor, or other stakeholders that are interested in the health and safety of agricultural commodities.

In one embodiment, completion of an agricultural task is verified through a task ticket generating system. For example, a task generator node 12 can generate a task ticket to be performed. Generation of tasks can be automated and/or manually generated by a user task generator 11. The task ticket can include a) the agricultural field where the agricultural task is to take place, and/or b) a type of a task to be performed (e.g., harvest, spray treatment, well treatment, watering). The task generator can be a computing device such as a mobile phone, a tablet computer, a desktop or laptop computer, a networked server, etc. The task performer can accept the generated task using the verifier node 10 and then perform the task.

The task generator node can verify the performance of the task. This can include requiring the verifier node 10 to capture an image showing completion of the task and store a geolocation of the task performer (e.g., using GPS or other equivalent technology of the verifier node) and verifying that the geolocation of the performer and node is in accordance with the location of the field (e.g., using the parameters generated by the performing node described above). This provides visual evidence as to which task was performed and evidence as to where the task was performed. It should be noted that the verification information (images, location data) can be sent from the verifier node to the task generator or from the verifier to the data manager, the path of the data not being germaine to the present disclosure in this scenario.

In one embodiment, the type of task generated and assigned can be describe an application of a treatment product (e.g., fertilizer and/or pesticide) to the agricultural field. Treatments of an agricultural field can be performed by spray, irrigation, and/or other means.

In one embodiment, the one or more completed agricultural tasks includes a) a named party that performed the agricultural task, b) a named party that verified the completion of the agricultural task, c) a treatment product, if applied to the agricultural field, and d) a quantity of the treatment product that was applied to the agricultural field.

Verification of proper completion of the treatment can be performed through the ticket generation system. A user can accept the treatment task through the verifying node (which can also be described as a performing node), thereby indicating intent to perform the task described in the ticket. The ticket can include a) the agricultural field where the treatment is to be applied, b) the treatment product to be applied to the field, and/or c) a quantity or rate of application of the treatment product to be applied. The treatment ticket can also specify who can accept the ticket or, in other words, who is assigned to the task.

Prior to application of the product, some tasks can require preparation of a treatment product. For example, the task generator may generate a task that requires a spraying of a treatment product, where the treatment product must first be combined at labeled ratios, stored in a particular container or in a particular environment, and applied through spray. The verifier node may require the performer to verify preparation of the treatment product—for example, scanning of one or more labels of products that are to be combined, mixed and used, and/or capturing an image of the treatment product prior to and/or after all is mixed. Labels can be affixed to wells to provide a well identifier, pesticides, well registrations, fertilizer, water wells, etc. Thus, scanning of the label indicates that the proper well, treatment chemical, or fertilizer is being used. In one embodiment, the location of the user can be referenced against a known location of an irrigation well to verify that the product is loaded into the correct irrigation well. The location of the user can be determined simultaneous with the scanning of the label, to sync the user's location with the scanned label. In one embodiment, images of the performer can be stored to verify proper personal protective equipment (PPE) was used during preparation.

The verifier node may also require verification of the application of the treatment product at the field. This can include storing a geolocation of the user and then referencing the user geolocation against the geolocation of the agricultural field to determine whether the treatment has occurred in the proper location. A time stamp can be recorded based on when the treatment product was applied to the field. User inputs, such as ‘start’ or ‘stop’ inputs can be generated by the user through a user interface, to indicate when such treatments are being applied.

The treatment product can be a fertilizer, a pesticide, water, or a combination thereof. In one embodiment, the data manager can update the data registry only with parameters that are verified. The data manager can determine when some parameters are not properly verified (e.g., the verification info is missing, or determined to be untrustworthy, or is otherwise compromised) and discard the data, or store it in the data registry, but with an indication that the parameters are not properly verified. An administrator 27 with administrator privileges can modify settings of the data registry to determine whether the unverified tasks are discarded or stored with such indicators.

Administrators can use an administrator node 26 such as a mobile phone, tablet computer, etc. for such purposes.

As mentioned, there are different types of agricultural tasks, including harvesting. If an agricultural commodity (for example, apples, lettuce, potatoes, etc.) is harvested at the agricultural field, then a unique identifier such as a sequence of numbers and/or characters can be associated with the harvested agricultural commodity and stored in the data registry.

In one embodiment, when a harvesting of an agricultural commodity occurs on the agricultural field, a task performer, using a verifier node 10 (e.g., a mobile phone, a bar code generator, or other equivalent device), can generate and/or assign the unique identifier to the harvested commodity. This can be bar code (e.g., UPC, EAN, Code 128, QR code, Code 39, Code 93, etc.) that can be physically coupled to the harvested commodity (e.g., by attaching as a sticker or otherwise tagging the product or crate).

In one embodiment, a harvester can use the node to generate one or more of the following: the harvester's current location (e.g., longitude and latitude coordinates), one or more images of the harvested commodity and/or the field, a unique identifier, and a type of agricultural commodity (e.g., honey crisp apples, organic spinach, etc.).

In one embodiment, administrators can have super user privileges such as being able to grant other users with access to the data registry. The data registry can be accessed through an API so that stakeholders can analyze the data to determine compliance status for different agricultural fields. Stakeholders can also audit all the practices performed on an agricultural field, and determine based on performance dates, which practices were relevant and performed on which product. The practices can be tied directly to a unique identifier of a harvested commodity.

In one embodiment, the task generator node and/or the data manager can determine, in response to an unperformed agricultural task, whether the unperformed task would violate a compliance requirement of the field associated with the compliance requirement, and provide a notification to a user indicating non-compliance of the unperformed agricultural task.

For example, if the task generator 11 generates a task that specifies that a treatment product be applied to a particular agricultural field, the data manager can determine, based on the records 17 in the data registry, whether application of a treatment product (or the amount to be applied) would violate any of the requirements associated with that agricultural field. If this is the case, the data manager can communicate to the task generator that the proposed task would violate such requirements. The task generator, can, in turn, provide a notification (e.g., through a display, email, text message, etc.) to the user that the proposed task is out of compliance with one or more requirements of the agricultural field. Thus, the task generator 11 can cancel or abort that task, or modify the task by specifying a different treatment product or a different quantity of treatment product to be applied to the agricultural field. An action that would put the agricultural field is thereby avoided.

In one embodiment, each of the one or more completed agricultural tasks are associated with a ticket identifier, stored in the data registry. The ticket identifier can be a name or number that is originally generated by the task generator node in administering the agricultural task. Further, an identifier for the issuer of the ticket (e.g., a name or identification number of the task generator) can also be stored in the data registry in association with each completed task. For example, a task generator can use the task generator node to generate and administer a task for watering an agricultural field. The task generator node assigns a ticket ID, which can be a unique ID, to the generated task. Once the task is verified to completion, the ticket ID and ticket originator can then be stored to provide traceability to the originator of the ticket. Time stamp of the ticket generation can be stored as well. Thus, the data registry can trace the task back to the ticket that was created to assign the task, and to the person that created the task.

In one embodiment, the data registry includes one or more farm identifiers associated with the agricultural fields. The farm identifier can be a unique identifier (e.g., a name and/or ID number) that represents a farm entity that is responsible for any of the agricultural fields that are associated with it. The farm identifier represents a farm entity that is responsible for any of the agricultural fields that are associated with it. For example, Frank's Potato Farm has ten different agricultural fields, each with its own set of boundaries, defined by geo coordinates. A farm identifier for Frank's Potato Farm can be stored in the data registry to be associated with those ten agricultural fields. Based on the records that are associated with the farm identifier, various queries can be performed on all fields of Frank's Potato Farm. An algorithm can compare all agricultural fields associated with the farm entity to a food and safety requirement (or any other requirement) to audit the entire practice of the farm entity across all agricultural fields.

It should be understood that the data registry can include various time stamps tied to various tasks and events. For example, the data registry can include time stamps for each performed task, the time stamps also being stored in the data registry. Each task can have multiple time stamps for different data items associated with each task, for example, a time stamp for harvest, a time stamp for application of a treatment product, a time stamp for scanning a label, a time stamp for a geolocation of the performer, a time stamp for an image that shows completion of a task, etc.

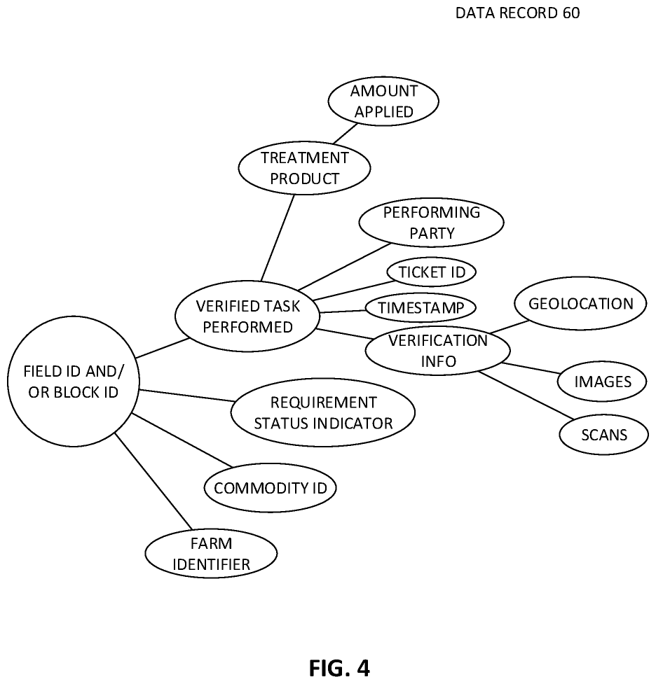

FIG. 4 shows a data record 60 according to one embodiment. The data record is merely an example of numerous possible data records. A field identifier and/or block identifier can have associated with it one or more verified tasks performed, indicating what type of task was performed. If the task included use of a treatment product, then such product can be included, as well as the amount applied to the agricultural field. The record can include a performing party (e.g., a name or identifier), a ticket identifier that was generated to assign the task to the performing party, and verification info (e.g., various geolocations of the performing party at different stages of the task, images of the task, scanned labels, etc.). As mentioned one or more timestamps are stored to memorialize when each event occurred. One or more requirement status indicators can be associated to each field and/or block. When a product is harvested, one or more commodity identifiers (e.g., bar codes) can be generated and stored in the data registry. Those same identifiers can be affixed to the harvested commodity so that the harvested commodity can be traced to the agricultural field/block and data associated therewith. A farm identifier can indicate which farm is responsible for the agricultural field/block.

Referring back to FIG. 1, it should be understood that nodes 10, 26, 14, data manager 14, data registry 16, and requirements manager 19 can be implemented through hardware and/or software of one or more computing devices. They can be implemented with the same computing device, or through separate computing devices. Computing devices can have known computer hardware such as but not limited to one or more processors, memory for storing executable instructions, memory for storing data, transmitters and receivers, power supplies, displays, etc. They can communicate over a network 98 through known communication protocols. Reference to ‘algorithm’ includes a series of steps or instructions performed by a computing device to determine an outcome or result.

The systems and processes described form an analytics framework for maintaining health and safety of agricultural products. By capturing the totality of the agricultural tasks performed on the crop and field, an analytics engine can certify farmer practice for compliance with health and safety requirements, thereby improving the health and safety of the crop.

Non-limiting embodiments of the invention include:

1. A method comprising:
maintaining a data registry having parameters associated with one or more agricultural fields, wherein for each of the one or more agricultural fields, the parameters include
   a) one or more geolocation parameters defining a location of the agricultural field,
   b) one or more completed agricultural tasks performed upon the agricultural field,
   c) if a compliance requirement is associated with the agricultural field, a compliance status that indicates whether or not the compliance requirement is satisfied; and
   d) if an agricultural commodity was harvested at the agricultural field, one or more unique identifiers that is associated with the harvested agricultural commodity;
in response to a verified completion of an agricultural task performed on one of the one or more agricultural fields,
   update the parameters associated with the agricultural field where the verified completed agricultural task was performed, and
   referencing updated parameters against the compliance requirement of the agricultural field to determine if the updated parameters violate the compliance requirement, and updating the compliance status to indicate whether or not the compliance requirement is satisfied.
      2. The method of embodiment 1, wherein the verified completion of the agricultural task is verified by a process, including:

accepting, by a task performer, a task ticket, the task ticket including a) the agricultural field where the agricultural task is to take place, and b) a type of a task to be performer;

verifying a performance of the task, including capturing an image of showing completion of the task and storing a geolocation of the task performer; the geolocation being in accordance with the location of the field.

3. The method of embodiment 2, wherein the type of the task includes treatment of the agricultural field with a treatment product, and a process that verifies the verified completion of the agricultural task includes:

accepting, by a user with an electronic device, a treatment ticket, the treatment ticket including a) the agricultural field, b) the treatment product to be applied to the field, c) a quantity or rate of application of the treatment product to be applied;

verifying a preparation of the treatment product, including scanning of a label, or capturing an image of the treatment product;

verifying the application of the treatment product at the field, including storing a geolocation of the user, the geolocation being in accordance with the location of the field.

4. The method of embodiment 3, wherein the treatment product is a fertilizer, a pesticide, or a combination thereof.
5. The method of embodiment 1, wherein the data registry includes a farm identifier associated with at least one of the agricultural fields, the farm identifier representing a farm entity that is responsible for any of the agricultural fields that are associated with it.
6. The method of embodiment 5, further comprising comparing all agricultural fields associated with the farm entity to a food and safety requirement to audit practice of the farm entity.
7. The method of embodiment 1, wherein the parameters further include one or more block identifiers, each block identifier indicating a partitioned area of the corresponding agricultural field.
8. The method of embodiment 1, wherein the one or more completed agricultural tasks includes a) a named party that performed the agricultural task, b) a named party that verified the completion of the agricultural task, c) a treatment product, if applied to the agricultural field, and d) a quantity of the treatment product that was applied to the agricultural field.
9. The method of embodiment 1, wherein each of the one or more completed agricultural tasks is associated with a ticket identifier that was generated to administer the corresponding completed agricultural task.
10. The method of embodiment 1, wherein the one or more geolocation parameters includes a latitude and longitude coordinate.
11. The method of embodiment 10, wherein the one or more geolocation parameters further define a boundary of the field.
12. The method of embodiment 11, wherein the compliance requirement is violated when the agricultural field is determined, based on the geolocation parameters, to be within a distance of a sensitive area.
13. The method of embodiment 1, further comprising comparing the parameters against one or more buyer provided requirements to determine whether the one or more agricultural fields satisfy the one or more buyer provided requirements.
14. The method of embodiment 1, further comprising, wherein the agricultural task is a harvesting of the agricultural commodity at the agricultural field, and in response to the harvesting of the agricultural commodity at the field, adding the one or more unique identifiers to the data registry in association with the agricultural field.
15. The method of embodiment 14, wherein the one or more unique identifiers are associated with bar codes that are physically coupled with the harvested agricultural commodity.
16. The method of embodiment 1, wherein access to at least part of the data registry is granted to one or more users by an administrator having granting privileges to assign the access.
17. The method of embodiment 1, wherein the data registry is maintained on a networked computing device.
18. The method of embodiment 1, wherein the data registry is maintained as a blockchain.
19. The method of embodiment 1, further comprising determining, in response to an unperformed agricultural task, whether the unperformed task would violate a compliance requirement of the field associated with the compliance requirement, and provide a notification to a user indicating non-compliance of the unperformed agricultural task.
20. A non-transitory machine readable storage medium having stored therein instructions that, when executed by a processor, perform the following:
maintaining a data registry having parameters associated with one or more agricultural fields, wherein for each of the one or more agricultural fields, the parameters include
   a) one or more geolocation parameters defining a location of the agricultural field,
   b) one or more completed agricultural tasks performed upon the agricultural field,
   c) if a compliance requirement is associated with the agricultural field, a compliance status that indicates whether or not the compliance requirement is satisfied; and
   d) if an agricultural commodity was harvested at the agricultural field, one or more unique identifiers that is associated with the harvested agricultural commodity;
in response to a verified completion of an agricultural task performed on one of the one or more agricultural fields,
   update the parameters associated with the agricultural field where the verified completed agricultural task was performed, and
   referencing updated parameters against the compliance requirement of the agricultural field to determine if the updated parameters violate the compliance requirement, and updating the compliance status to indicate whether or not the compliance requirement is satisfied.
      21. A computer having a non-transitory machine readable storage medium having stored therein instructions that, when executed by a processor, perform a method of any one of embodiments 1-19.
      22. A system comprising one or more networked nodes, wherein one or more of the nodes comprises a non-transitory machine readable storage medium having stored therein instructions that, when executed by a processor of the node, perform a method of any one of embodiments 1-19.

What is claimed is:

1. A method comprising:
maintaining a data registry having parameters associated with one or more agricultural fields, wherein for each of the one or more agricultural fields, the parameters include
a) one or more geolocation parameters defining a location of the agricultural field,
b) one or more completed agricultural tasks performed upon the agricultural field,
c) if a compliance requirement is associated with the agricultural field, a compliance status that indicates whether or not the compliance requirement is satisfied; and
d) if an agricultural commodity was harvested at the agricultural field, one or more unique identifiers that is associated with the harvested agricultural commodity;
in response to a verified completion of an agricultural task performed on one of the one or more agricultural fields,
update the parameters associated with the agricultural field where the verified completed agricultural task was performed, and
referencing updated parameters against the compliance requirement of the agricultural field to determine if the updated parameters violate the compliance requirement, and updating the compliance status to indicate whether or not the compliance requirement is satisfied.

2. The method of claim 1, wherein the verified completion of the agricultural task is verified by a process, including:
accepting, by a task performer, a task ticket, the task ticket including a) the agricultural field where the agricultural task is to take place, and b) a type of a task to be performer;
verifying a performance of the task, including capturing an image of showing completion of the task and storing a geolocation of the task performer; the geolocation being in accordance with the location of the field.

3. The method of claim 2, wherein the type of the task includes treatment of the agricultural field with a treatment product, and a process that verifies the verified completion of the agricultural task includes:
accepting, by a user with an electronic device, a treatment ticket, the treatment ticket including a) the agricultural field, b) the treatment product to be applied to the field, c) a quantity or rate of application of the treatment product to be applied;
verifying a preparation of the treatment product, including scanning of a label, or capturing an image of the treatment product;
verifying the application of the treatment product at the field, including storing a geolocation of the user, the geolocation being in accordance with the location of the field.

4. The method of claim 3, wherein the treatment product is a fertilizer, a pesticide, or a combination thereof.

5. The method of claim 1, wherein the data registry includes a farm identifier associated with at least one of the agricultural fields, the farm identifier representing a farm entity that is responsible for any of the agricultural fields that are associated with it.

6. The method of claim 5, further comprising comparing all agricultural fields associated with the farm entity to a food and safety requirement to audit practice of the farm entity.

7. The method of claim 1, wherein the parameters further include one or more block identifiers, each block identifier indicating a partitioned area of the corresponding agricultural field.

8. The method of claim 1, wherein the one or more completed agricultural tasks includes a) a named party that performed the agricultural task, b) a named party that verified the completion of the agricultural task, c) a treatment product, if applied to the agricultural field, and d) a quantity of the treatment product that was applied to the agricultural field.

9. The method of claim 1, wherein each of the one or more completed agricultural tasks is associated with a ticket identifier that was generated to administer the corresponding completed agricultural task.

10. The method of claim 1, wherein the one or more geolocation parameters includes a latitude and longitude coordinate.

11. The method of claim 10, wherein the one or more geolocation parameters further define a boundary of the field.

12. The method of claim 11, wherein the compliance requirement is violated when the agricultural field is determined, based on the geolocation parameters, to be within a distance of a sensitive area.

13. The method of claim 1, further comprising comparing the parameters against one or more buyer provided requirements to determine whether the one or more agricultural fields satisfy the one or more buyer provided requirements.

14. The method of claim 1, further comprising, wherein the agricultural task is a harvesting of the agricultural commodity at the agricultural field, and in response to the harvesting of the agricultural commodity at the field, adding the one or more unique identifiers to the data registry in association with the agricultural field.

15. The method of claim 14, wherein the one or more unique identifiers are associated with bar codes that are physically coupled with the harvested agricultural commodity.

16. The method of claim 1, wherein access to at least part of the data registry is granted to one or more users by an administrator having granting privileges to assign the access.

17. The method of claim 1, wherein the data registry is maintained as a blockchain.

18. The method of claim 1, further comprising determining, in response to an unperformed agricultural task, whether the unperformed task would violate a compliance requirement of the field associated with the compliance requirement, and provide a notification to a user indicating non-compliance of the unperformed agricultural task.

19. A non-transitory machine readable storage medium having stored therein instructions that, when executed by a processor, perform the following:
maintaining a data registry having parameters associated with one or more agricultural fields, wherein for each of the one or more agricultural fields, the parameters include
a) one or more geolocation parameters defining a location of the agricultural field,
b) one or more completed agricultural tasks performed upon the agricultural field,
c) if a compliance requirement is associated with the agricultural field, a compliance status that indicates whether or not the compliance requirement is satisfied; and
d) if an agricultural commodity was harvested at the agricultural field, one or more unique identifiers that is associated with the harvested agricultural commodity;
in response to a verified completion of an agricultural task performed on one of the one or more agricultural fields,
update the parameters associated with the agricultural field where the verified completed agricultural task was performed, and
referencing updated parameters against the compliance requirement of the agricultural field to determine if the updated parameters violate the compliance requirement, and updating the compliance status to indicate whether or not the compliance requirement is satisfied.

20. A system comprising one or more networked nodes, wherein one or more of the nodes comprises a non-transitory machine readable storage medium having stored therein instructions that, when executed by a processor of the node, perform the following:
maintaining a data registry having parameters associated with one or more agricultural fields, wherein for each of the one or more agricultural fields, the parameters include
a) one or more geolocation parameters defining a location of the agricultural field,
b) one or more completed agricultural tasks performed upon the agricultural field,
c) if a compliance requirement is associated with the agricultural field, a compliance status that indicates whether or not the compliance requirement is satisfied; and
d) if an agricultural commodity was harvested at the agricultural field, one or more unique identifiers that is associated with the harvested agricultural commodity;
in response to a verified completion of an agricultural task performed on one of the one or more agricultural fields,
update the parameters associated with the agricultural field where the verified completed agricultural task was performed, and
referencing updated parameters against the compliance requirement of the agricultural field to determine if the updated parameters violate the compliance requirement, and updating the compliance status to indicate whether or not the compliance requirement is satisfied.
